(19) United States
(12) Patent Application Publication
(10) Pub. No.: US 2012/0059133 A1
(43) Pub. Date: Mar. 8, 2012

(54) Method of Making Chemically Resistant Moulds and Tools

(76) Inventor: Duncan Howland, Hesingue (FR)

(21) Appl. No.: 13/263,757

(22) PCT Filed: Feb. 24, 2010
(86) PCT No.: PCT/EP2010/052325

§ 371 Date: Oct. 10, 2011

(30) Foreign Application Priority Data
Apr. 24, 2009 (EP) 09158740.2

(51) Int. Cl. C08L 63/00; B05D 3/12; B05D 5/00

(52) U.S. Cl. 525/524; 427/289; 525/523

(57) ABSTRACT

A method of producing a tool or mould is claimed which comprises (A) application of a seamless modelling paste comprising at least one resin system (a) and at least one hardener system (b) onto a substrate to form a continuous film of curable material (B) curing the seamless modelling paste. The composition used comprises a resin system (a) comprising an epoxy resin (a1) having an average epoxy functionality above 2 and the hardener system (b) comprising an amine compound (b1) having an average amine functionality above 2.

### FIELD OF THE INVENTION

The present invention relates to a two-component curable composition comprising a resin component and a hardener component and to the use of the curable composition for making seamless moulds and tools.

### BACKGROUND OF THE INVENTION

Curable two-component compositions are used in a wide variety of fields, for example adhesives, fibre reinforced composites, modelling pastes, coatings, sealants, putties, mastics, stopping compounds, caulking materials, encapsulants and surface coatings such as paints. The curing time of such compositions after mixing of the components depends on many factors, e. g. the nature of the curable materials and the temperature. Examples of widely known 2-component resins systems include epoxy/amine; isocyanate/polyol and epoxy/anhydride systems and also hybrid systems such as epoxy; acrylate/amine and epoxy; isocyanate/polyol; amine systems.

Model making within the automotive, aerospace, rail, wind turbine and marine industries depends widely on such compositions. There is a need to produce dimensionally accurate master models, particularly of larger format. These models are used by engineers for the fabrication of production moulds for part manufacture. More and more, these industries seek to remove the master model step and directly fabricate functional moulds.

Moulds for use in the composite manufacture industry are often themselves made with composite materials, especially utilising thermoset resin compositions with fibre or mineral reinforcements.

Specifically, the moulds detailed in this invention are employed for making parts by curing liquid thermoset resins, which for example contain unsaturated polyester (UPE) or vinyl ester (VE) in solutions with reactive monomers like vinylic or acrylic monomers (in particular styrene) cured by free radical polymerisation. Curing of these unsaturated polyesters (UPE) or vinyl esters (VE) compositions can generally only be accomplished in the presence of these additional reactive unsaturated monomer like substituted or unsubstituted styrene, vinyl monomers, acrylates or methacrylates. However, theses reactive monomers can cause degradation of moulds.

Production of moulds typically requires a full scale master or model (often referred to as a plug) onto which the mould is formed, typically using liquid thermoset resins, by a process of lamination with fibre reinforcements, or casting with mineral filler reinforcements.

Seamless Modelling Pastes (SMP's) are used for production of master models. Until now, no satisfactory method existed for directly producing a mould (i.e. without the use of a master model) from SMP compositions, which offers sufficient chemical resistance to the reactive monomers employed in liquid thermoset resin compositions (especially styrene) so as to enable series part production of more than 1-5 parts. Formerly, chemical and physical attack of the SMP composition's surface took place during part manufacture, causing a degredation of surface quality, which increased strongly with the number of parts made. Chemical attack of this nature is widely accepted to come from the reactive monomers and low molecular weight solvents used in the formulation of thermoset resins. Chemical resistance is often measured using immersion testing of samples in a reactive monomer, such as is commonly used in thermoset resins. Absorption by samples immersed in styrene for 14 days can usefully indicate the resistance of the material to styrene attack: absorption is expressed as a percentage of sample weight. Existing formulations typically display a styrene absorption (14 days 40° C.) of greater than 15% by weight.

In WO2006/024676 a composition for making high temperature resistant models and tools is disclosed. The composition contains an epoxy resin, a thixotropic agent and a hardener system comprising at least one polyethyleneimine, at least one other amine having at least two amino hydrogen groups and at least one other epoxy curative having latent reactivity, wherein components of the hardener system are present in an amount sufficient to effect cure of the epoxy resin.

WO03/051649 discloses another process for making models free of bond lines. In the claimed process a low density thixotropic curable paste is used which comprises a resin composition and microballoons. The resin may comprise an epoxy resin, a thixotropic agent and a hardener comprising at least one polyethyleneimine and at least one other amine having at least two amine hydrogen groups.

The chemical resistance to styrene and other low molecular weight monomers is poor. The cured compositions absorb styrene, with the consequence that the cured composition swells and cracking can be observed, causing further degredation.

Thus, there is a need for curable compositons useful for making models or tools having improved chemical resistance to low molecular weight monomers. Additionally, such compositions should have the required physical characteristics to enable the production of a seamless mould for moulding thermoset resin monomer solutions. A requirement for the curing process of curable compositions is that the heat of reaction is not too high, i.e. the peak exotherm during curing is low enough so as not to cause distortion or damage of the supporting sub-structure material. Furthermore, the composition should have a rheology such that the compositions may be applied to form a seamless film with non-slump properties, even when applied to a vertical surface at thickness up to 30 mm, low shrinkage and exotherm during cure, good milling properties and mechanical resistance.

### SUMMARY OF THE INVENTION

The subject matter of the present invention is a method for producing a tool or mould comprising:

(A) application of a seamless modelling paste comprising at least one resin system (a) and at least one hardener system (b) onto a substrate to form a continuous film of curable material
(B) curing the seamless modelling paste,
characterized in that the resin system (a) comprises an epoxy resin (a1) having an average epoxy functionality above 2 and the hardener system (b) comprises an amine compound (b1) having an average amine functionality above 2.

A further Subject matter of present invention is a curable composition comprising
(a) a resin system comprising an epoxy resin (a1) having an average epoxy functionality above 2,
and
(b) a hardener system comprising an amine compound (b1) having an average amine functionality above 2.

Surprisingly it has been found that methods for producing a tool or mould using the specified composition yield parts with superior properties. In particular the the chemical resistance was considerably improved.

The composition according to the invention can be used as a seamless modelling paste and for the preparation of seamless moulds, models and tools. According to the invention, the preferred components of the method are also the preferred components of the composition.

### DETAILED DESCRIPTION OF THE INVENTION

In the method according to the present invention a seamless modelling paste is used which comprises a two-component curable composition which comprises (a) a special resin system and (b) and a special hardener system.

The method of present invention may be conveniently applied using machine dispensing/ mixing equipment. In an additional step (C) of the method, the SMP layer is machined to the final form.

The resin system (a) may consist of one or more epoxy resins which are themselves liquid or may be a liquid mixture of one or more solid epoxy resins with one or more liquid epoxy resins or may be one or more solid epoxy resins dissolved in a diluent such as any diluent conventionally used in epoxy resin compositions.

The epoxy resin (a1) may be selected from any epoxy resins containing more than 2 functional groups in its molecule. In a preferred embodiment of present invention, the resin system (a) may comprise epoxy resins (a1) having an epoxy functionality of 3 or more. The epoxy resin (a1) having 3 or more functional groups is preferably selected from glycidylamines, more preferably from N,N,N′,N′- tetraglycidyl-4,4′methylene bisbenzenamine, triglycidyl p-aminophenol, triglycidyl m-aminophenol or any mixture of these. Polyglycidyl ethers of bisphenol A and glycidylamines are especially preferred. Examples of suitable glycidylamines are Araldite® MY 0600-CH, MY 721 and MY 0510 from Huntsman and ^{Tetrad}® X and ^{Tetrad}® C available from Misubushi Gas Chemicals Co.

Preferably, the resin system (a) further comprises an epoxy resin (a2) with an average functionality ≦2.

The epoxy resin (a2) is preferably selected from epoxy compounds which are mono or diglycidyl ethers of a polyhydric alcohol such as 1,4-butanediol or 1,3-propanediol or, preferably, a mono- or diglycidyl ether of a polyhydric phenol, for example a bisphenol such as bis(4-hydroxyphenyl)methane (bisphenol F) or 2,2-bis-(4-hydroxyphenyl)propane (bisphenol A), or a mono- or diglycidyl ether of a novolak formed from formaldehyde and a phenol, such as phenol itself or a cresol. Mixtures of these compounds can be used as well.

In a preferred embodiment the epoxy resin (a) is a mixture of epoxy resins having an epoxy functionality of 3 or more (a1) and mono- or difunctional epoxy resins (a2). The resin component comprises the epoxy resin (a1) preferably in an amount of at least 10 wt.-%, based on the total weight of the resin component.

It has been found that the the chemical resistance is significantly improved when the average epoxy functionality of the resin system is above 6.3 eq./kg based on the resin components.

In a preferred embodiment, the resin component (a) further comprises an acrylate and/or methacrylate monomer (a3)—denoted as (meth)acrylate. The (meth)acrylate monomer (a3) may be selected from esters of (meth)acrylic acid or oligomers thereof and is present in an amount of 1 to 20 wt.-%, based on the total weight of the resin system (a). Component (a3) is useful in reducing the peak exotherm temperature during curing.

The hardener system (b) comprises an amine compound (b1) having an average amine functionality above 2, preferably an average amine functionality ≧3, in particular ≧4.

The amine compound having an average amine functionality above 2, preferably 3 or more, is preferably selected from polyalkylenepolyamines Preferred examples are diethylenetriamine, triethylenetetramine, tetraethylenepentamine, dipropylenetriamine or tripropylenetetramine; N-hydroxyalkyl derivatives of polyalkylene polyamines such as N-(hydroxyethyl) diethylenetriamine or mono-N-2-hydroxypropyl derivative of triethylenetetramine; polyoxyalkylenepolyamines such as polyoxyethylene- and polyoxypropylene triamines; cycloaliphatic polyamines having an amino or aminoalkyl group attached to the ring; aromatic polyamines; amine-terminated adducts of epoxy resins with aliphatic, cycloaliphatic or araliphatic amines as described above; N-aminoalkyl piperazines with three amino groups or more; and polyaminoamides, for example reaction products of polyalkylenepolyamines, such as those mentioned above, with polymerised unsaturated fatty acids, e.g. polymerised vegetable oil acids such as trimerised linoleic or ricinoleic acids. According to the invention any mixture of these amines may be used.

In a preferred embodiment of the method, the hardener system additionally comprises an amino compound having an average amine functionality ≦2. Compounds (b2) are preferably selected from alkylenemono- or diamines; polyalkylenemono- or diamines; N-hydroxyalkyl derivatives of polyalkylene; polyoxyalkylenemono- or diamines; N,N-dialkylalkylenemono- or diamines; cycloaliphatic mono- or diamines having an amino or aminoalkyl group attached to the ring; aromatic mono- or diamines; amine-terminated adducts of epoxy resins with aliphatic, cycloaliphatic or araliphatic mono- or diamines; N-aminoalkyl-piperazines; and mono-or diaminoamides or a mixture of two or more of such amines

Aromatic, aliphatic and cycloaliphatic amine hardeners are usually preferred for use as component (b) of the composition. The amount of (b) preferably ranges from about 0.75 to 1.25 amino hydrogen equivalents per 1,2-epoxide equivalent of the epoxy resin (a). In a preferred embodiment of the present invention the hardener system (b) comprises a mixture of amine compounds, i.e. a mixture of mono-/diamine compounds and of polyamine compounds. The average amino functionality of the amino compounds present in the hardener system (b) is above 2.

The resin component (a) may further comprise a thixotropic agent. The thixotropic agent is preferably a thixotropic agent which relies largely on interparticle hydrogen bonding to achieve its thixotropic effect, especially a hydrophilic fumed silica or another silicate. The amount of thixotropic agent required to induce thixotropic properties may depend on the nature of the specific epoxy resin and specific thixotropic agent used. This amount is generally from 1 to 20%, preferably from 3 to 15%, by weight based on the weight of the resin component (1). This is a “physical” thixotropic agent.

Preferably, the composition contains also a thixotropic enhancing agent which increases (physical) thixotropy when mixed with the thixotropic agent. A preferred thixotropic enhancing agent is polyethyleneimine which may have a molecular weight (Mw) from 700 to 1000000 or more, preferably from 5000 to 1000000, especially from 25000 to 1000000, particularly 500000 to 1000000 and most preferably 500000 to 750000. Such polyethyleneimines are commercially available or may be prepared from ethyleneimine by known procedures.

In certain specific embodiments of the invention, the amount of polyethyleneimine is such that the epoxy resin composition does not flow prior to its gelation, which in some instances requires several hours. The amount of polyethyleneimine needed to impart non-flow properties for a given time can be readily determined by simple experiment. For compositions of the invention containing the especially preferred components an amount of polyethyleneimine from 0.2 to 2 parts by weight per 100 parts by weight of the epoxy resin is preferred.

The epoxy resin composition may be formed conveniently by stirring a preformed mixture of the components of the resin system (a) together with a preformed mixture of the hardener system (b). The thixotropic agent may also be conveniently present in the resin or hardener mixture.

The two-component curable composition prepared in accordance with the present invention may also contain additional ingredients, such as diluents, fillers (such as calcium carbonate), fibres, pigments, dyes, fire retardants, antifoaming agents, wetting agents and polymeric toughening agents. These auxiliary materials may be conveniently added with the resin or hardener component.

The two-component curable composition according to the invention is preferably used as a seamless modelling paste. Techniques for dispensing modelling pastes are known in the art, e.g. by using Tartler Nodopox machinery. Conveniently, separate drums are filled with the resin and hardener components. The application of low pressure via a follower plate to the drums facilitates pumping of the materials. Preferably, pumps deliver the resin and hardener from the drums to a mix block where the resin, and hardener are mixed. The residence time in the mix block, the speed of mechanical stirring and the length of the hose attached to the chamber influence the homogeneity of the mixture.

It is particularly preferred to use low viscosity resin mixtures, the preferred viscosity range is 1 to 1000 Pa·s at 25° C. (TA Instruments AR-G2, 25° C., 20 mm plate/plate, shear rate 100s⁻¹). Too high a viscosity in the components results in a need for high pressure pumping to dispense the paste. Much higher viscosity compositions are those applied known in the art as patties, which are semi-solid and are neither pumpable nor machine dispensable.

Preferred compositions should have a temperature resistance in the range 60 to 130° C. .

Preferably, the paste is used to create the mould by the production of a smooth and machineable top surface covering the support. A layer of the paste is dispensed onto the support structure surface with a high-output meter-mix machine in the form of a continuous layer covering the entire model, top surface as well as sides [sloping or vertical]. The paste is preferably applied at a thickness of about 5 mm to about 30 mm thick, more preferably at about 15 mm thick. It is required to exhibit good non-slump and sag resistance properties when applied on a vertical surface. Typically, a minimum sag resistance of a 25 mm thickness on a vertical surface is required. The paste is then cured and machined. The pastes according to the invention particularly give seamless bonding allow for smooth surfaces to produce high functionality moulds and tools.

Cure of the curable resin can be affected in accordance with conventional practice in the particular application. In general, the composition is allowed to cure at ambient temperature. Optionally, at this stage, the part may be machined to approximate dimensions, then post cured to effect full reaction, final machining to the required dimensions may then be performed. The surfaces may be treated to seal the surface or provide a non stick surface before the mould or tool is put into production.

In order to meet the overall requirements for an acceptable temperature resistant material, the cured composition should have a heat deflection temperature (HDT) over 50° C., and preferably over 70° C.

Machining or cutting can be carried out using conventional tools (e.g. lathe) or cutting machines, such as milling machines, machining centres and the like, in order to achieve the desired shape. The use of a computer numerical control (CNC) machine is preferred. The present invention is therefore suitable for the production of master models, moulds and tools.

It will be appreciated that the total fabrication process of a mould or tool using the method of the present invention is simplified, more economical and faster than a conventional method which requires additionally the fabrication of a master model, for example using metal, wood, plaster, mastics, fibre reinforced laminates and modelling pastes, and subsequently the fabrication of a mould. An additional and important advantage is that the resulting model surface over the whole area [top as well as vertical or sloping sides] is seamless and free of bondlines.

In addition to the advantages mentioned above (namely a faster process, better machinability, smoother surface characteristics, and greater overall efficiency), the paste used in the present invention exhibits low linear shrinkage and can be used to produce large moulds which are dimensionally very stable. The finished article has excellent edge strength, cured shore hardness, flexural strength, high heat deflection temperature and compressive strength, as well as a low thermal expansion coefficient.

The present invention will now be illustrated by reference to the following non-limiting examples. All parts and percentages are provided on a weight basis unless indicated otherwise.

### EXAMPLES

### Examples of the Invention

The tables given below show example formulations of typical seamless modelling pastes and comparative SMPs as described in earlier publications , plus details of this invention.
The following terminology is used:

### Mix Ratio

The ratio (given in volume and weight) of resin and hardener mixed together to make the cured samples.

### Peak Exotherm

The two components are mixed to give a paste-like composition (Seamless Modelling Paste=SMP) at a starting temperature of 23° C. and then applied at 30 mm thickness to an expanded polystyrene substrate (density 30 kg/m⁻³) and placed in an oven at 40° C. to cure. A thermocouple is inserted to measure the temperature at the centre of the paste layer. Peak exotherm is defined as the highest temperature measured in the SMP during the cure of the material.

### Density

Density of cured formulation is determined at 23° C. (ISO 1183).

### Hardness

Shore D penetrometer (ISO 868).

### Glass Transition Temperature (Tg)

Measured by DSC, 10° C./ min on fully cured material (IEC 1006)

### Styrene Absorption Measures

Samples are cut to size (40×40×10 mm) and weighed on an accurate balance before being immersed in styrene for 14 days at 40° C. Following immersion, all samples are allowed to dry on absorbent paper for 1 hour at 23° C. before reweighing. Absorption is expressed as a percentage of sample weight.

### Raw Materials Used

TABLE 1

| Type | Name | Supplier | Purpose |
|---|---|---|---|
| Bisphenol A | Araldite ® GY 240 | Huntsman | Standard |
| epoxy resin | | | BADGE |
| | | | epoxy |
| | | | resin |
| | Araldite ® GY 260 | | Standard |
| | | | BADGE |
| | | | epoxy |
| | | | resin |
| Multifunctional | Araldite ® MY 0510 | Huntsman | Triglycidyl |
| epoxy resin | | | ether of |
| | | | para- |
| | | | aminophenol. |
| | | | Epoxide |
| | | | functionality 3. |
| Acrylic | M Cure ® 400 | Sartomer | Aliphatic |
| monomer | | | acrylate |
| | | | monomer |
| Benzyl alcohol | Benzyl alcohol | Numerous | Diluent |
| Aliphatic | Jeffamine ® D-230 | Huntsman | Di-functional |
| polyether | | | aliphatic |
| amine | | | polyether |
| | | | amine |
| | | | curing |
| | | | agent |
| Triethylene | Aradur ® HY 951 | Huntsman | Tetra- |
| tetramine | | | functional |
| | | | amine |
| | | | curing |
| | | | agent |
| Wetting agent | Byk ® W969 | Byk Chemie | Wetting |
| | | | agent |
| Antifoam | Antifoam ® MSA | Dow Corning | Prevents |
| agent | | | foaming |
| Polyethylene | HM Polymin | BASF | Enhancer |
| imine | Lupasol ® P | | for |
| | | | fumed |
| | | | silica |
| Polyvinyl | Mowital ® B 75 H | Kuraray | Viscosity |
| Butyrate | | | modifier |
| Fumed Silica | Aerosil ® 380 | Degussa | Thixotrope |
| | Cabosil ® TS720 | Cabosil | agents |
| Mineral filler | Durcal ® 5 | Omya | Calcium |
| | | | carbonate |
| | | | filler |
| Glass micro- | Scotchlite ® K25 | 3M | Hollow |
| spheres | Sillite ® S60 | Sil-Trade | micro |
| | | | spheres |

TABLE 2
Examples 1 and 2: typical epoxy seamless modelling pastes (WO03051649);
comparative
Example 3: High temperature resistance SMP (WO06024676), comparative

| | | | Comp. Ex. 1 | Comp. Ex. 2 | Comp. Ex. 3 |
|---|---|---|---|---|---|
| Resin System (parts by weight) | | | | | |
| Bisphenol A epoxy resin | | | 50 | 46 | 20 |
| Bisphenol F epoxy resin | | | | 6 | |
| MY 0510 multifunctional epoxy resin | | | | | 42 |
| Reactive diluents | | | 2.5 | 4 | |
| Non-reactive diluents | | | 5 | 2.5 | |
| Acrylate monomer | | | 5 | | |
| Calcium stearate | | | 4 | | 4 |
| PTFE Powder | | | | | 4 |
| Non-reactive colorants | | | 1.5 | 2 | |
| Mineral filler | | | 25 | 23 | 10 |
| Thixotropic agent | | | 5 | 1.5 | 6 |
| Thermoplastic hollow spheres | | | 2 | | |
| Glass hollow spheres | | | | 15 | 14 |
| Hardener System (parts by weight) | | | | | |
| Aliphatic polyether amine | | | | 39 | 24 |
| Cycloaliphatic amine/bis A epoxy adduct | | | 25 | | |
| Diphenyl diamino sulphone | | | | | 8 |
| Diethyltoluene diamine | | | | | 22 |
| Polyol | | | 25 | | |
| Non-reactive diluents | | | 6 | 5 | |
| Silicone surfactant | | | 0.02 | 0.3 | |
| PTFE powder | | | | | 4 |
| Mineral filler | | | 39 | 33 | 27 |
| Thixotropic agent | | | 3 | 7.7 | 3 |
| Thermoplastic hollow spheres | | | 1.98 | | |
| Glass hollow spheres | | | | 15 | 12 |
| Resin:hardener ratio (parts by weight) | | | 100:100 | 100:50 | 100:50 |
| Resin:hardener ratio (parts by volume) | | | 100:100 | 100:50 | 100:50 |
| Peak exotherm | | | 67° C. | 85° C. | 103° C. |
| Density 23° C. | | | 0.75 gcm⁻³ | 0.9 gcm⁻³ | 1.0 gcm⁻³ |
| Shore D hardness 23° C. | | | 60 | 70 | 80 |
| Tg Max (DSC) | | | 71° C. | 60° C. | 209° C. |
| Styrene | RT cure | Styrene | 29.8% | 19.4% | 4.42% |
| immersion: | (23° C.) | absorption (% | | | |
| 14 days at | | by weight) | | | |
| 40° C. | | Visual aspect | Severe swelling | Completely | Some cracking |
| | | | | cracked/broken | |
| | RT cure + | Styrene | 29.6% | 19.0% | 1.68% |
| | 12 h 60° C. | absorption (% | | | |
| | | by weight) | | | |
| | | Visual aspect | Severe swelling | Completely | Some cracking |
| | | | | cracked/broken | |

TABLE 3
Formulations 1-5: examples of invention (Table 3)

| | | | Formulation 1 | Formulation 2 | Formulation 3 |
|---|---|---|---|---|---|
| Resin System (parts by weight) | | | | | |
| GY 240 Bisphenol A epoxy resin | | | 46 | 46 | 23 |
| GY 260 Bisphenol A epoxy resin | | | | | |
| MY0510 epoxy resin | | | | | 23 |
| Acrylate monomer M-cure 400 | | | 6 | 6 | 6 |
| Blue pigment paste DW 0135 | | | 0.6 | 0.6 | 0.6 |
| Benzyl alcohol | | | 0.8 | 0.8 | 0.8 |
| Wetting agent Byk W969 | | | 0.6 | 0.6 | 0.6 |
| Antifoam MSA | | | 0.02 | 0.02 | 0.02 |
| Calcium carbonate | | | 28.98 | 28.98 | 28.98 |
| Calcium Stearate S | | | | | |
| Fumed silica Aerosil 380 | | | 2 | 2 | 2 |
| Glass hollow spheres Scotchlite K25 | | | 15 | 15 | 15 |
| Glass hollow spheres Sillite S60 | | | | | |
| Hardener System (parts by weight) | | | | | |
| Aliphatic polyether amine Jeffamine D-230 | | | 42.6 | 35.6 | 42.6 |
| Triethylene tetramine | | | | 7 | |
| Wetting agent Byk W969 | | | 1 | 1 | 1 |
| Antifoam MSA | | | 0.02 | 0.02 | 0.02 |
| Polyethylene imine | | | 0.7 | 0.7 | 0.7 |
| Benzyl alcohol | | | 0.7 | 0.7 | 0.7 |
| Polyvinyl butyrate Mowital B 75 H | | | 2 | 2 | 2 |
| Brown pigment paste DW 0136 | | | | | |
| Iron oxide yellow pigment Bayferrox 420 | | | 1 | 1 | 1 |
| Calcium carbonate Durcal 5 | | | 37.68 | 37.68 | 37.68 |
| Fumed silica Cabosil TS720 | | | 0.8 | 0.8 | 0.8 |
| Glass hollow spheres Scotchlite K25 | | | 13.5 | 13.5 | 13.5 |
| Resin:hardener ratio (parts by weight) | | | 100:46 | 100:37 | 100:60 |
| Resin:hardener ratio (parts by volume) | | | 100:46 | 100:37 | 100:60 |
| Peak Exotherm | | | — | — | — |
| Density 23° C. | | | 0.86 gcm⁻³ | 0.86 gcm⁻³ | 0.86 gcm⁻³ |
| Shore D hardness 23° C. | | | 75 | 75 | 75 |
| Tg Max (DSC) | | | 58° C. | 73° C. | 74° C. |
| Styrene | RT cure | Styrene absorption | 10.6% | 5.47% | 2.68% |
| immersion: | (23° C.) | (% by weight) | | | |
| 14 days at | | Visual aspect | Severe | Slight surface | Slight surface |
| 40° C. | | | cracking | deformation | deformation |
| | RT cure + | Styrene absorption | 6.06% | 1.47% | 0.85% |
| | 12 h 60° C. | (% by weight) | | | |
| | | Visual aspect | Severe | No visible | No visible |
| | | | cracking | change | change |

| | | | Formulation 4 | Formulation 5 |
|---|---|---|---|---|
| Resin System (parts by weight) | | | | |
| GY 240 Bisphenol A epoxy resin | | | | 23 |
| GY 260 Bisphenol A epoxy resin | | | 27 | |
| MY0510 epoxy resin | | | 27 | 23 |
| Acrylate monomer M-cure 400 | | | 6 | 6 |
| Blue pigment paste DW 0135 | | | 0.3 | 0.6 |
| Benzyl alcohol | | | | 0.8 |
| Wetting agent Byk W969 | | | | 0.6 |
| Antifoam MSA | | | 0.02 | 0.02 |
| Calcium carbonate | | | 18.08 | 28.98 |
| Calcium Stearate S | | | 4 | |
| Fumed silica Aerosil 380 | | | 2.6 | 2 |
| Glass hollow spheres Scotchlite K25 | | | | 15 |
| Glass hollow spheres Sillite S60 | | | 15 | |
| Hardener System (parts by weight) | | | | |
| Aliphatic polyether amine Jeffamine D-230 | | | 42.5 | 35.6 |
| Triethylene tetramine | | | 7.5 | 7 |
| Wetting agent Byk W969 | | | | 1 |
| Antifoam MSA | | | | 0.02 |
| Polyethylene imine | | | 0.5 | 0.7 |
| Benzyl alcohol | | | 0.5 | 0.7 |
| Polyvinyl butyrate Mowital B 75 H | | | | 2 |
| Brown pigment paste DW 0136 | | | 0.3 | |
| Iron oxide yellow pigment Bayferrox 420 | | | | 1 |
| Calcium carbonate Durcal 5 | | | 31.4 | 37.68 |
| Fumed silica Cabosil TS720 | | | 2.3 | 0.8 |
| Glass hollow spheres Scotchlite K25 | | | 15 | 13.5 |
| Resin:hardener ratio (parts by weight) | | | 100:50 | 100:50 |
| Resin:hardener ratio (parts by volume) | | | 100:72 | 100:50 |
| Peak Exotherm | | | 142° C. | 109° C. |
| Density 23° C. | | | 1.0 gcm⁻³ | 0.86 gcm⁻³ |
| Shore D hardness 23° C. | | | 85 | 75 |
| Tg Max (DSC) | | | 96° C. | 87° C. |
| Styrene | RT | Styrene absorption (% by | 1.05% | 1.69% |
| immersion: | cure | weight) | | |
| 14 days at | (23° C.) | Visual aspect | No visible | No visible |
| 40° C. | | | change | change |
| | RT | Styrene absorption (% by | 0.29% | 0.16% |
| | cure + | weight) | | |
| | 12 h | Visual aspect | No visible | No visible |
| | 60° C. | | change | change |

Comparative Examples 1 and 2 (standard SMP pastes) show styrene absorption in the order of 20-30%, and the samples showed heavy cracking after immersion.
Comparative Example 3 (high temperature resistance SMP) shows much lower styrene absorption, but is very brittle when cured at low temperatures (20° C. to 60° C.), and tends to break in use. Some cracking is also visible after immersion. A minimum post-cure temperature of 140° C. is necessary in order to make the cured paste dimensionally stable, and therefore suitable for producing precision parts. This high post-cure temperature makes this product unsuitable for a range of applications where only low to medium temperatures can be achieved (20° C. to 60° C.).
Formulation 1 is an improvement of a standard SMP paste, not containing any diluents. The styrene absorption is significantly reduced compared to the standard examples. However, the composition shows severe cracking after styrene immersion.
Formulations 2 and 3 contain a proportion either of high functionality (i.e. functionality>2) amine or epoxy resin respectively. The styrene absorption is reduced in both cases compared to formulation 1. The surface aspect is also much improved after immersion.
Formulation 4 contains both the high functionality resin and hardener, and offers a further reduction of styrene absorption compared to formulations 2 and 3. No visible change of the immersed samples was visible after 14 days immersion at 40° C.
The liquid (uncured) properties of the resin, hardener and mixed paste are such as to render it suitable for pumping and mixing in specialist application machines as are commonly employed in the application of SMP. However, the product mix ratio by volume (100 resin : 72 hardener) is not a desirable ratio for use on pumping/dosing machines.
The Tg of the formulation is such that the formulation is able to withstand the temperatures encountered in the moulding of unsaturated polyester and other liquid thermoset resins without deforming, which is important for a tool.
Exotherm and hardness of the formulation are somewhat high, which may limit the usefulness of this formulation in practice. High exotherm in thick layer can cause distortion and cracking, so application thickness of this formulation is likely to be rather limited. High hardness makes the formulation difficult to mill to the desired final dimensions, which is undesirable for this type of product.

Formulation 5 contains both the high functionality resin and hardener, and has similar styrene absorption as formulation 4. No visible change of the immersed samples was visible after 14 days immersion at 40° C.

The liquid properties of the two components still make this formulation suitable for pumping and application. Moreover, the mixing ratio is improved to 100 resin: 50 hardener by weight and volume, making it highly suitable for pumping/dosing machines.

The density of this formulation is lower than formulation 4, which reduces the exotherm of the material during cure, and also the hardness, making it easier to mill to final dimensions. These characteristics are beneficial to the application of the material to produce seamless moulds.

The experimental results for formulation 5 indicate the excellent performance characteristics, notably a rheology and mix ratio suitable for machine pumping and mixing, low styrene absorption, lack of deformation after immersion and good temperature resistance, all combined with the ability to use the product with a cure temperature of only 20-60° C.

1. A method of producing a tool or mould comprising:
(A) application of a seamless modelling paste comprising at least one resin system (a) and at least one hardener (b) onto a substrate to form a continuous film of curable material
(B) curing the seamless modelling paste and
(C) machining of the cured seamless modelling paste to form the tool or mould
characterized in that the resin system (a) comprises an epoxy resin (a1) having an average epoxy functionality above 2 and the hardener system (b) comprises an amine compound (b1) having an average amine functionality above 2.

2. (canceled)

3. The method according to claim 1, wherein the resin system (a) comprises an epoxy resin (a1) having an average epoxy functionality of ≧3.

4. The method according to claim 3, characterized in that the epoxy resin (a1) is a polyfunctional glycidylamine selected from N,N,N′,N′-tetraglycidyl-4,′methylene bisbenzenamine, triglycidyl p-aminophenol, triglycidyl m-aminophenol and a mixture thereof.

5. The method according to claim 1, characterized in that resin system (a) further comprises an epoxy resin (a2) with an average functionality ≦2, selected from a mono- or diglycidyl ether of a polyhydric alcohol, a mono- or diglycidyl ether of a polyhydric phenol, a mono- or diglycidyl ether of a novolak formed from formaldehyde and a phenol, and a mixture thereof.

6. The method according to claim 1, characterized in that resin system (a) is a mixture of epoxy resins having an epoxy functionality of 3 or more (a1) and a mono- or difunctional epoxy resin or a mixture of mono- or difunctional epoxy resins (a2)

7. The method according to claim 1, wherein the resin system (a) comprises an average epoxy functionality above 6 equivalents/kg.

8. The method according to claim 1, characterized in that the resin system additionally comprises at least one (meth)acrylate monomer (a3) in an amount of 1 to 20 wt. % based on the total weight of the resin system (a).

9. The method according to claim 1, characterized in that the hardener system (b) comprises an amine compound (b1) having an average amine functionality ≧3.

10. The method according to claim 9, characterized in that the amine compound (b1) comprises a polyalkylenepolyamine.

11. (canceled)

12. (canceled)

13. (canceled)

14. (canceled)

15. (canceled)

16. The method according to claim 9 characterized in that the amine compound (b1) is diethylenetriamine, triethylenetetramine, tetraethylenepentamine, dipropylenetriamine, tripropylenetetramine, N-(hydroxyethyl) diethylenetriamine, N-2-hydroxypropyl derivative of triethylenetetramine, poloxyethylenetriamine, polyoxypropylenetriamine, a cycloaliphatic polyamine having an amino or aminoalkyl group attached to the ring, an aromatic polyamine, an amine-terminated adduct of an epoxy resin with aliphatic, cycloaliphatic or araliphatic polyamine, an N-polyaminoalkyl-piperazine, a polyaminoamide or a mixture thereof.

17. The method according to claim 9 characterized in that the hardener system (b) further comprises an amino compound (b2) having an amine functionality ≦2.

18. A tool or model produced according to the method of claim 1.

19. A curable seamless modelling paste comprising
(a) a resin system comprising an epoxy resin (a1) having an average epoxy functionality above 2, and
(b) a hardener system comprising an amine compound (b1) having an average amine functionality above 2.

20. The curable seamless modelling paste of claim 19 wherein component (a) further comprises an epoxy resin (a2) with an average functionality ≦2, selected from a mono- or diglycidyl ether f a polyhydric alcohol, a mono- or diglycidyl ether of a polyhydric phenol, a mono- or diglycidyl ether of a novolak formed from formaldehyde and a phenol, and a thereof and component (b) further comprises an amino compound (b2) having an amine functionality ≦2.
